(19) United States
(12) Patent Application Publication
(10) Pub. No.: US 2005/0026597 A1
(43) Pub. Date: Feb. 3, 2005

(54) Method for retransmitting a radio resource control connection request message in mobile communication system capable of providing a multimedia broadcast/multicast service

(75) Inventors: Soeng-Hun Kim, Suwon-si (KR); Kyeong-In Jeong, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/909,882

(22) Filed: Aug. 2, 2004

(30) Foreign Application Priority Data
Aug. 1, 2003 (KR) 2003-53423

(51) Int. Cl. H04M 11/00

(52) U.S. Cl. 455/412.1; 455/403

(57) ABSTRACT

A method for controlling a UE (User Equipment) to retransmit an RRC (Radio Resource Control) connection request message in a mobile communication system capable of providing an MBMS (Multimedia Broadcast/Multicast Service). The method includes the steps of determining, by an RRC layer of the UE, if a control message including a timer value corresponding to a cell having the UE is received from a RNC (Radio Access Controller); transmitting the RRC connection request message to the BSC over an uplink common channel when the control message is equal to an MBMS control message; and repeatedly transmitting the RRC connection request message in response to the timer value until receiving a response message from the BSC.

### PRIORITY

This application claims priority to an application entitled “METHOD FOR RETRANSMITTING RRC CONNECTION REQUEST MESSAGE IN MOBILE COMMUNICATION SYSTEM CAPABLE OF PROVIDING MULTIMEDIA BROADCAST/MULTICAST SERVICE (MBMS)”, filed in the Korean Intellectual Property Office on Aug. 1, 2003 and assigned Ser. No. 2003-53423, the contents of which are incorporated herein by reference.

### BACKGROUND OF THE INVENTION

1. Field of the Invention

The present invention relates to an MBMS (Multimedia Broadcast/Multicast Service) for use in a mobile communication system, and more particularly to a method for controlling a UE (User Equipment) to effectively retransmit an RRC (Radio Resource Control) connection setup message.

2. Description of the Related Art

With the increasing development of the communication technologies, a conventional CDMA (Code Division Multiple Access) mobile communication system is rapidly changing to a packet service communication system capable of transferring a large amount of data, for example voice data, packet data, and circuit data, etc., and is also developing into a multimedia communication system or multimedia broadcast communication system capable of transferring multimedia services. A new MBMS capable of multicasting a service from one or more data sources to a plurality of UEs (User Equipments) has been developed to support the multimedia broadcast communication system. The MBMS supports a variety of multimedia transmission data, for example real-time video and audio data, still images, and text data, etc., simultaneously provides audio and video data according to the applications of the multimedia transmission data, and requests a large amount of transmission resources. A plurality of UEs may use the same service, such that the MBMS may also be provided to the UEs over a broadcast channel.

The MBMS service can perform a Point-to-Point (PTP) service for providing the UEs with their desired MBMS services and a Point to Multi-point (PTM) service for providing the UEs with the same MBMS data requested by the UEs. In this case, according to the number of UEs requesting to receive the MBMS data associated with one MBMS service or the transmission power of a network capable of supporting the MBMS service, the MBMS service may first perform the PTP service for each cell, and may change the PTP service to the PTM service if needed. The MBMS service may also first perform the PTM service, and then may change the PTM service to the PTP service if needed.

A network structure based on an asynchronous mobile communication scheme for supporting the MBMS will hereinafter be described with reference to FIG. 1.

Referring to FIG. 1, a UE (User Equipment) 130 directly receives a corresponding MBMS, and includes hardware and/or software for supporting the MBMS. A UTRAN (UMTS Radio Access Network) is indicative of a wireless communication network for connecting the UE 130 with a Core Network (CN) 100. The UTRAN includes a plurality of RNCs (Radio Access Controllers) 111 and 112, a plurality of Node Bs 115, 113, 114 and 116 controlled by the RNCs 111 and 112, and a plurality of cells contained in individual Node Bs.

The RNC 111 controls the Node Bs 115 and 113, and controls a plurality of cells contained in each of the Node Bs 115 and 113. The RNC 112 includes and controls the Node Bs 114 and 116 and a plurality of cells controlled by the Node Bs 114 and 116.

The number of Node Bs controlled by the RNCs 111 and 112 and the number of cells contained in each Node B are determined by a service provider and the individual performance characteristics of the RNC and the Node B. The UE 130 and the UTRAN 110 are connected to each other via a Uu interface. The Uu interface is a term of art in the 3GPP (3rd Generation Partnership Project), and is an interface between the UE 130 and the UTRAN 110. The UTRAN 110 is connected to the CN 100 (SGSN) via an Iu interface. The Iu interface is a term of art in the 3GPP, and is an interface associated with components contained in the UTRAN 110 and the CN 100.

FIG. 2 is a block diagram illustrating a frame protocol structure for use in a mobile communication system.

Referring to FIG. 2, upper-layer messages processed by the UTRAN are largely processed by a Control Plane (C-Plane) signal 201 and User Plane (U-Plane) data 202. The C-Plane 201 signal and the U-Plane 202 data are messages of a Non Access Stratum (NAS). The NAS messages are messages that are unused in a radio access between the UE and the UTRAN, and are messages not required for the UTRAN to recognize the contents of the messages.

Contrary to the NAS messages, other messages directly used for the radio access between the UTRAN and the UE are called AS (Access Stratum) messages. The AS messages are data or control signals used in various components positioned under a Radio Resource Control (RRC) 211 of FIG. 2.

The C-Plane 201 signal includes the RRC 211, an L2/RLC (Radio Link Control) 241, an L2/MAC (Medium Access Control) 271, and a Physical Layer (hereinafter referred to as an L1) 291. The U-Plane 202 signal includes an L2/PDCP (Packet Data Convergency Protocol) 221, an L2/BMC (Broadcast/Multicast Control) 231, the L2/RLC 241, the L2/MAC 271, and the physical layer 291.

The physical layer 291 performs a variety of functions, for example channel coding/decoding, modulation/demodulation, and channelization/dechannelization, etc., such that the physical layer 291 converts data into a wireless or radio signal, and converts the received wireless or radio signal into data. Transport channels 281 transfer information between the physical layer 291 and the L2/MAC 271.

The physical channels of the transport channel 281 include a P-CCPCH (Primary Common Control Channel) for transmitting a BCH (Broadcast channel), an S-CCPCH (Secondary Common Control Physical Channel) for transmitting a PCH (Paging Channel) and an FACH (Forward Access Channel), a DPCH (Dedicated Physical Channel) for transmitting a DCH (Dedicated Channel), a PDSCH (Physical Downlink Shared Channel) for transmitting a DSCH (Downlink Shared Channel), an HS-PDSCH (High Speed Physical Downlink Shared Channel) for transmitting an HS-DSCH (High Speed Downlink Shared Channel), and a PRACH (Physical Random Access Channel) for transmitting an RACH (Random Access Channel). The physical channels also include a pilot channel, a purely physical channel that is unable to transmit either upper-layer data or a control signal, a Primary Synchronization Channel, a Secondary Synchronization Channel, a Paging Indicator Channel, an Acquisition Indicator Channel, and a Physical Common Packet Channel. The physical layer 291 is connected to the L2/MAC 271 over a transport channel 281.

The transport channel 281 defines the methods for controlling how specific data is to be processed in the physical layer 291. For example, there is a channel coding scheme, a transport block set size capable of being transmitted during one unit time, etc. The categories and functions of the transport channel are described in Table 1.

TABLE 1

| Categories | Functions |
|---|---|
| Broadcast channel (BCH) | BCH is mapped to BCCH to transmit |
| | BCCH data |
| Paging Channel (PCH) | PCH is mapped to PCCH to transmit |
| | PCCH data |
| Random Access Channel (RACH) | RACH is adapted for transmission |
| | from UE to network, is adapted for |
| | network access, control message and |
| | transmission of short data |
| Forward Access Channel (FACH) | FACH is adapted to transmit control |
| | message and data from network to |
| | specific UE or UEs, and may be |
| | mapped to BCCH, CTCH, CCCH, |
| | DCTH, and DCCH |
| Dedicated Channel (DCH) | DCH is channel for transmitting data |
| | and control signal between network |
| | and UE, and is mapped to DTCH and |
| | DCCH |
| Downlink Shared Channel (DSCH) | DSCH is downlink channel from |
| | network for high-capacity data |
| | transmission to UE, and is mapped to |
| | DTCH and DCCH |
| High Speed DSCH (HS-DSCH) | HS-DSCH is downlink channel from |
| | network having improved |
| | transmission efficiency to UE, and is |
| | mapped to DTCH and DCCH |

The L2/MAC 271 transmits data received from an RLC to the physical layer 291 over a proper transport channel 281, and transmits the data received from the L2/MAC 271, i.e. from the physical layer 291 over the transport channel 281, to the L2/RLC 241 over a logical channel 261. The L2/MAC 271 inserts additional information in the data received from either the physical channel 261 or the transport channel 281, or analyzes the inserted additional information, such that it can perform a proper operation. The logical channel 261 is largely classified into a dedicated-type channel associated with a specific UE, and a common-type channel associated with a plurality of UEs. The logical channel 261 is also classified into a control-type channel and a traffic-type channel according to its message characteristics. Categories and functions of the logical channel are described in Table 2.

TABLE 2

| Categories | Functions |
|---|---|
| Broadcast channel (BCH) | BCH is adapted for a downlink |
| | transmission from a UTRAN to a UE, |
| | and transmits UTRAN system control |
| | information |
| Paging Control Channel (PCCH) | PCCH is adapted for a downlink |
| | transmission from a UTRAN to a UE, |
| | and transmits control information to a |
| | UE when it the position of cell the UE |
| | is unknown |
| Common Control Channel | CCCH is adapted to transmit control |
| (CCCH) | information between a UE and |
| | network, and is used when there is no |
| | connection channel between a UE and |
| | an RRC |
| Dedicated Control Channel | DCCH is adapted to transmit 1:1 |
| (DCCH) | control information between a UE and |
| | a network, and is used when a UE is |
| | connected to an RRC |
| Common Traffic Channel | CTCH is adapted for point - to - |
| (CTCH) | multipoint data transmission between a |
| | network and UEs |
| Dedicated Traffic Channel | DTCH is adapted for 1:1 data |
| (DTCH) | transmission between a network and a |
| | UE |

The L2/RLC 241 receives a control message transferred from the RRC 211 to be sent to the UE, and configures the received control message using an RLC#1 251 and an RLC#m 252 according to the characteristics of the control message. The control message is then transmitted to the L2/MAC 271 over the logical channel 261. The L2/RLC 241 receives data from the L2/PDCP 221 and the L2/BMC 231, and configures the data using the RLC#1 253 and the RLC#n 254 into an appropriate form. The data is then transmitted to the L2/MAC 271 over the logical channel 261. The L2/RLC 241 acts as one of an AM (Acknowledged Mode), a UM (Unacknowledged Mode), and a TM (Transparent Mode), and different functions are assigned to individual modes. The RLC#1 251, the RLC#m 252, the RLC#1 253, and the RLC#n 254 are RLC entities operated by one of the modes.

The L2/PDCP 221 is positioned at an upper layer along with the L2/RLC 241, and performs a header compression function of data transmitted in the form of an IP (Internet Protocol) packet and prevents loss of a packet when a serving RNC is switched to another due to a UE's mobility. The L2/BMC 231 is positioned at an upper layer along with the L2/RLC 241, and supports a broadcast service capable of transmitting the same data to a plurality of UEs contained in a specific cell. The RRC 211 assigns the radio resources at a specific position between the RNC and the UE, or releases the assigned radio resources from the specific position.

The modes of a specific UE for receiving the MBMS in the 3GPP are classified into a connected mode and an idle mode. The connected mode is a specific state in which the RRC 211 is capable of communicating a control signal or data with a specific UE as can be seen from FIG. 2, and the RRC 211 recognizes information associated with the UE. A component needed for the connected mode is an RRC connection. The RNC transmits the radio resources assigned to the UEs, the mobility of the UEs, and the CN signals to be transmitted to the UEs to a corresponding UE using the RRC connection.

In the case of the idle mode, the RRC 211 does not know the presence of the specific UE, such that there is no communication method of a control signal or data between the RRC 211 and the specific UE. The UE 130 of the idle mode performs the RRC connection with the RNC 111 such that it must receive radio resources for transmission/reception of the control signals, etc. The aforementioned process is an RRC connection setup process, and its detailed description will hereinafter be described with reference to FIG. 3.

FIG. 3 is a flow chart illustrating a radio resource connection setup process between the UTRAN and the UE.

Referring to FIG. 3, if the UE 130 is turned on or needs to be transitioned from an idle mode to a connected mode, the UE 130 transmits an RRC connection request message to the RNC 111 contained in the UTRAN 110 at step 310. The RRC connection request message is transmitted over an RACH (Random Access Channel) of a cell that contains the UE 130, and generally contains the following information, i.e. a UE's ID (Identifier) and an RRC connection setup cause value.

The UE's ID is an IMSI (International Mobile Station Identification) or a TMSI (Temporary Mobile Station Identification), and an ID for allowing the CN 100 to recognize the UE 130.

The RRC connection setup cause value an of RRC connection setup cause information of the UE, and includes predetermined setup cause values, for example incoming signal generation, outgoing signal generation, and control message generation, etc.

Upon receipt of the RRC connection request message including the UE ID information and the RRC connection setup cause information, the RNC 111 performs the following operations, i.e. an SRB (Signaling Radio Bearer) setup and radio resource assignment operation and a UE context generation operation.

In the case of the SRB setup and radio resource assignment operation, the RNC establishes an SRB, and assigns corresponding radio resources to the assigned SRB. The SRB is a general term for the logical channels, transport channels, and layers contained in the C-Plane of FIG. 2. The establishment of the SRB means that the RLC, the MAC, and the physical layer are established to transmit a control message and the transport channel for interconnecting the individual layers, and the logical channel are established. If the SRB has been established as described above, the RNC 111 must assign the radio resources to be used for the SRB. The assignment process may be performed by an NBAP (Node B Application Part) between the Node B and the RNC.

In the case of the UE context generation operation, the RNC 111 having assigned radio resources generates a UE context, in which information associated with the UE 130 is to be stored, and stores the control information determined in the aforementioned process. Thereafter, the control information associated with a corresponding UE is updated by the UE context.

The RNC 111 having finished the radio resource assignment operation transmits the RRC connection setup message to the UE 130 over an FACH (Forward Access Channel) at step 320.

The RRC connection setup message includes a parameter associated with the determined SRB, etc. The UE 130 determines the SRB according to the parameters contained in the RRC connection setup message, and then transmits an RRC connection setup completion message to the RNC 111 in step 330. The RRC connection setup completion message may include the capability information of the UE if needed. The RNC 130 having received the message stores the UE's capability information in the UE context, and terminates the RRC connection setup process. The UE's capability information is not limited to the MBMS, and is indicative of a channel processing capability of individual UEs. The individual UEs have different capability information.

In association with the RRC connection setup process, the UE 130 transmits the RRC connection request message using a timer-based retransmission technique. If the UE 130 does not receive the RRC connection setup message from the RNC 111 during a predetermined period of time after transmitting the RRC connection request message, the UE 130 re-transmits the RRC connection request message to the RNC 111. In this case, a timer is used for retransmission of the RRC connection request message and is referred to as a T300. The UE is informed of the timer's use by adapting an SIB1 (System Information Block1) as a cell parameter.

In the case of determining a value of the T300, the RNC 111 must consider the following items, i.e. T_air_{—}1, T_Iub_{—}1, T_processing_RNC, T_Iub_{—}2, and T_air_{—}2.

T_air_{—}1 is a radio channel transmission expectation time of the RRC connection request message, and is fixed to 10 msec.

T_Iub_{—}1 is a transmission expectation time of the RRC connection request message in the Iub interface for connecting the RNC to the Node B, and is determined by the Iub interface category and the size of the RRC connection request message.

T_processing_RNC is an RRC connection request message processing time of the RNC, and is determined by a load applied to a processor of the RNC at a time at which the RRC connection request message is processed.

T_Iub_{—}2 is a transmission expectation time of the RRC connection setup message in the Iub interface, and is determined by the Iub interface category and the size of the RRC connection request message.

T_air_{—}2 is a radio channel transmission expectation time of the RRC connection setup message, includes a transmission time over the FACH, and includes a standby time during which the message is in a standby mode in the RLC before the message is transmitted over the FACH.

A scheduling process is required because the FACH transmits a control message for a plurality of UEs, etc., such that the aforementioned standby time is needed. The data transmitted over the FACH enters a standby mode in a buffer of the RLC until it is scheduled and transmitted.

The RNC 111 determines an appropriate T300 taking into consideration the aforementioned components, and informs the UEs of the T300 using the SIB1. In this case, if the RNC 111 sets the value of the T300 to an excessively high value, an excessively long period of time is consumed for the RRC connection setup process. Otherwise, if the RNC 111 sets the value of the T300 to an excessively low value, unnecessary retransmission of the RRC connection request message occurs.

Under the communication environment capable of supporting the MBMS, the RNC may process a plurality of RRC connection request messages at a specific time. For example, one notification message commands the UEs contained in a cell controlled by the RNC to generate a plurality of RRC connection request messages. Therefore, provided that the retransmission of the RRC connection request message is controlled using the T300 calculated by taking into consideration only a typical communication environment without considering an MBMS communication environment for transmitting a plurality of RRC connection request messages, this retransmission control method is ineffective.

In more detail, the T300 does not consider the situation during which the RNC processes the RRC connection request messages, such that it is determined to be a time value less than a proper time value. The UEs unavoidably encounter the problem of retransmission of consecutive RRC connection request messages.

The T300 introduces and determines a predetermined case in which the RRC connection request message is transmitted to a small number of UEs at a specific time, such that the aforementioned problem occurs.

FIG. 4 depicts a network structure of a mobile communication system for performing the MBMS and a flow chart of a message transmission operation. In more detail, FIG. 4 is a flow chart illustrating a process for providing the MBMS in a specific cell.

Referring to FIG. 4, a service announcement (hereinafter referred to as an announcement) process at step 500 transmits a plurality of basic information related to a corresponding service, for example an MBMS service ID, a service start time, and a service duration time, to the UE in such a way that a MBMS service can be provided to the UE. In this case, the MBMS service ID may be composed of a multicast address (hereinafter referred to as a multicast IP address) and an APN (Access Point Name). The UE having acquired the basic information associated with the MBMS via the announcement process at step 500 transmits an activation MBMS PDP context request message to the CN network when there is a specific MBMS to be received. In this case, the CN network is an SGSN. The SGSN recognizes the MBMS reception request generated from the UE, and transmits an activation MBMS PDP context accept message corresponding to the activation MBMS PDP context request message to a corresponding UE at step 502. The SGSN transmits a session start message indicating the start of an MBMS to the RNC including the UE having requested the MBMS, at the last moment of the start time of the MBMS requested by the UE at step 503.

The RNC transmits a service notification message (hereinafter referred to as a notification message) over a common channel, such as a paging channel, to call a plurality of UEs in which the MBMS is to be received at steps 504 and 514. A plurality of UEs are called by transmitting the notification message at steps 504 and 514. In more detail, the RNC calls a UE (UE1) in which the MBMS is to be received at step 504, and calls a plurality of UEs in which the MBMS is to be received at step 514. The above steps 504 and 514 are contrary to the typical call procedure, and perform a group paging function. The called UE1 begins the RRC connection setup procedure in association with the MBMS at step 505. The called UEn begins the RRC connection setup procedure in association with the MBMS at step 515. In more detail, if the UEs that wish to receive the MBMS are positioned in the cell, the number of RRC connection request messages transferred at the above steps 505 and 515 is determined to be greater than 1. The RNC counts the number of UEs having transmitted the RRC connection request message at step 506, such that the category of a radio channel to be used for the cell can be determined. The aforementioned procedure is called a counting procedure. If the number of UEs that wish to receive a specific MBMS in a specific cell is less than a predetermined number, a transmission procedure of MBMS data over a dedicated channel instead of a common channel is more effective. Otherwise, if the number of the UEs having requested the MBMS is equal to or greater than a predetermined number, the use of the common channel is more effective. The counting process at the above step 506 is required to determine whether the number of UEs who wish to receive the MBMS in the cell is equal to or greater than a predetermined number. If the number of UEs is equal to or greater than a predetermined number, the RNC transmits a stop message, such that it interrupts an RRC connection setup attempt of the UE1 which has not established the RRC connection at step 507. The RNC transmits the stop message, such that it interrupts an RRC connection setup attempt of the UEn which has not established the RRC connection at step 517. The SGSN transmits a channel QoS (Quality of Service) parameter to the RNC over an MBMS RAB (Radio Access Bearer) assignment request message at step 508. The RNC determines the MBMS RB (Radio Bearer) information of individual cells on the basis of the received QoS information and the counting result of the above step 506. The MBMS RB information may include Layer 2 (L2) information and Layer 1 (L1) information. In this case, the L2 information includes an RLC (Radio Link Control)/PDCP (Packet Data Convergence Protocol)—associated information, etc. The L1 information may include the TFS (Transport Format Set) information, the TFCS (Transport Format Combination Set) information, first channelization code information, first Transmit Power—associated information, second channelization code information, second Transmit Power—associated information, and activation time information, etc. Therefore, the RNC determines the aforementioned information for every cell in which a common radio channel is established, and determines the information for every UE within a cell in which a dedicated radio channel is established. The RNC transmits the MBMS RB information to the UE1 at step 509. The RNC transmits the MBMS RB information to the UEn at step 519. The MBMS is provided to UE1 through UEn over the established MBMS RB at step 510.

In other words, as can be seen from the procedure for providing the MBMS, a group paging procedure for every cell is required, such that the called or paging UEs transmit the RRC connection request messages at the same time, and the RNC must unavoidably process the RRC connection request messages received at the same time. In this case, the RNC has a disadvantage in that it is unable to process all of the RRC connection request messages within a specific time satisfying the T300 time requirements, and the UEs must unnecessarily retransmit the RRC connection request messages.

### SUMMARY OF THE INVENTION

Therefore, the present invention has been made in view of the above and other problems, and it is an object of the present invention to provide a method for controlling a UE to effectively retransmit an RRC connection setup message.

It is another object of the present invention to provide a method for controlling a RNC (Radio Access Controller) to determine the time information needed for the retransmission of the RRC connection message in a mobile communication system capable of supporting the MBMS.

It is yet another object of the present invention to provide a method for controlling the BSC to transmit the time information needed for the retransmission of the RRC connection message to the UE in a mobile communication system capable of supporting the MBMS.

It is yet another object of the present invention to provide a method for controlling the UE to transmit the RRC connection message using the time information needed for the retransmission of the RRC connection message received from the BSC in a mobile communication system capable of supporting the MBMS.

In accordance with one aspect of the present invention, the above and other objects can be accomplished by controlling a UE (User Equipment) to perform an RRC (Radio Resource Control) connection in a mobile communication system capable of supporting an MBMS (Multimedia Broadcast/Multicast Service), by determining, by a RNC (Radio Access Controller), a timer value corresponding to the MBMS; inserting the determined timer value in a notification message indicating a start of the MBMS, and transmitting the notification message and the inserted timer value to the UE; and transmitting, by the UE, an RRC connection request message to the BSC during a time period equal to the determined timer value.

In accordance with another aspect of the present invention, there is provided a method for controlling a UE (User Equipment) to effectively perform an RRC (Radio Resource Control) connection in a mobile communication system capable of supporting an MBMS (Multimedia Broadcast/Multicast Service), by determining, by a RNC (Radio Access Controller), a timer value corresponding to a cell including a UE requesting an MBMS; inserting the timer value in a notification message indicating a start of the MBMS, and transmitting the information message and the inserted timer value to the UE; and transmitting, by the UE, an RRC connection request message to the BSC during a time period equal to the determined timer value.

In accordance with yet another aspect of the present invention, there is provided a method for controlling a UE (User Equipment) to transmit an RRC (Radio Resource Control) connection request message in a mobile communication system capable of supporting an MBMS (Multimedia Broadcast/Multicast Service), by determining, by an RRC layer of a UE, if a control message including a timer value corresponding to a cell having the UE is received from a RNC (Radio Access Controller); transmitting the RRC connection request message to the BSC over an uplink common channel when the control message is equal to an MBMS control message; and repeatedly transmitting the RRC connection request message in response to the timer value until receiving a response message from the BSC.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an UTRAN (UMTS Radio Access Network);

FIG. 2 is a block diagram illustrating a frame protocol for a mobile communication system;

FIG. 3 is a flow chart illustrating a radio resource connection setup procedure between the UTRAN and the UE;

FIG. 4 is a flow chart illustrating an MBMS provision procedure for a conventional mobile communication system;

FIG. 5A is a flow chart illustrating a procedure for transmitting re-established time information using MBMS system information in accordance with a preferred embodiment of the present invention;

FIG. 5B is a flow chart illustrating a procedure for including time information in an MBMS notification message, and transmitting the time information with the MBMS notification message in accordance with another preferred embodiment of the present invention; and

FIG. 6 is a flow chart illustrating a procedure for controlling a UE to re-transmit an RRC connection setup message in accordance with the present invention.

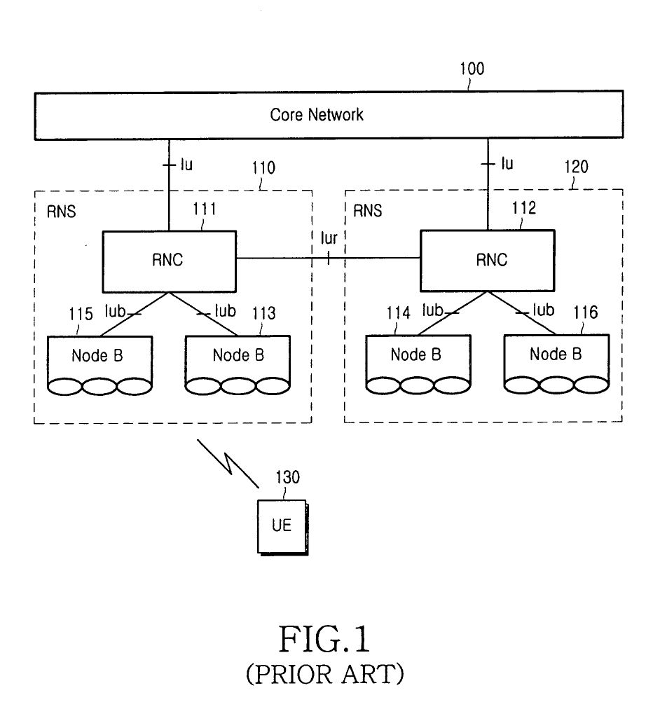

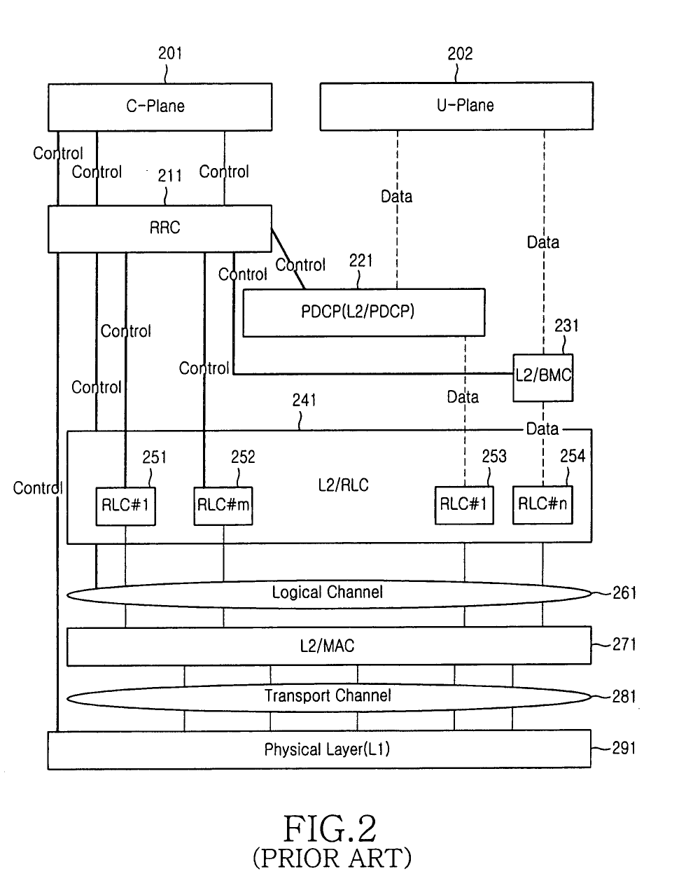

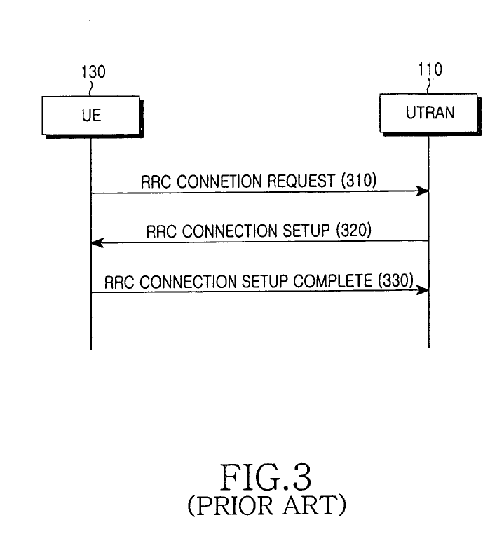

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following, a detailed description of known functions and configurations incorporated herein will be omitted when it may obscure the subject matter of the present invention.

There has recently been proposed a communication method for supporting a multimedia multicast scheme in the UMTS communication system. The communication method is referred to as an MBMS (Multimedia Broadcast/Multicast Service).

The MBMS is a service for multicasting the same multimedia data to a plurality of receivers over a radio network. When the MBMS is provided or its beginning impends, a plurality of UEs may attempt to simultaneously establish an RRC connection.

The present invention proposes a method for optimizing the setting of a timer in response to the support of the MBMS, instead of transmitting the RRC connection request message to a small number of UEs during a predetermined T300′ timer specified period of time. The present invention proposes a method for effectively controlling the retransmission of the RRC connection request message using an additional T300′ timer needed for a group paging.

The present invention proposes a method for effectively controlling retransmission of a plurality of RRC connection request messages in response to the support of the MBMS using the T300′ timer.

The present invention will first disclose a method for controlling the RNC to determine a timer value T300′ to be used in a multicast condition, will second disclose a method for transmitting the timer value T300′ determined by the RNC to the UEs, and will third disclose a method for controlling the UE to re-transmit the RRC connection request message using the timer value T300′.

The present invention uses different timers in a normal state and a multicast state when determining the timer for managing the retransmission operations of the RRC connection request message, and controls an appropriate timer according to the different states, resulting in a minimal number of retransmissions of unnecessary RRC connection request messages.

There are two methods for determining the T300′ time, and their detailed description will hereinafter be described.

The first method determines the T300′ according to MBMS services using the RNC. The RNC determines the T300′ by taking into consideration the following parameters. In the following description, a cell is a cell controlled by the RNC, and a Node B is a Node B controlled by the RNC.

T_air_{—}1 is a radio channel transmission expectation time of the RRC connection request message, and is fixed to 10 msec.

T_Iub_{—}1 is a transmission expectation time of the RRC connection request message in the Iub interface for connecting the RNC to the Node B, and is determined by the Iub interface category and the size of the RRC connection request message.

T_processing_RNC is an RRC connection request message processing time of the RNC, and is determined by a load applied to a processor of the RNC at a time at which the RRC connection request message is processed.

T_Iub_{—}2 is a transmission expectation time of the RRC connection setup message in the Iub interface, and is determined by the Iub interface category and the size of the RRC connection request message.

T_air_{—}2 is a radio channel transmission expectation time of the RRC connection setup message, includes a transmission time of the RRC connection setup message over the FACH, and includes a standby time during which the message is in a standby mode in the RLC before it is transmitted over the FACH.

A “margin” may be set to equal the sum of the above parameters plus a redundant margin.

Therefore, the T300′ may be denoted by Equation (1):
T300′=T_air_{—}1+T_Iub_{—}1+T_processing_{—}RNC+T_Iub_{—}2+T_air_{—}2+MARGIN (1)

The remaining parameters other than the T_air_{—}1 (i.e. T_Iub_{—}1, T_processing_RNC, T_Iub_{—}2, and T_air_{—}2) have variable sizes according to the number of UEs for each cell and the number of UEs for each RNC. For example, the size of the T_processing_RNC varies with the number of UEs (hereinafter referred to as #_UE_RNC) which expect to transmit the RRC connection request message in response to the MBMS-associated control message received at a processing speed of one RNC. The T_Iub_{—}1 and the T_Iub_{—}2 are positioned in one Node B, and their sizes vary with the number of UEs (hereinafter referred to as #_UE_NB) which will transmit the RRC connection request message in response to the received MBMS-associated control message. The T_air_{—}2 is positioned in one cell, and its size varies with the number of UEs (hereinafter referred to as #_UE_cell) which expect to transmit the RRC connection request message in response to the received MBMS-associated control message.

Therefore, the RNC experimentally calculates a correlation from among the #_UE_RNC, the T_processing_RNC, the #_UE_NB, the T_Iub_{—}1, the T_Iub_{—}2, the #_UE_cell, and the T_air_{—}2, and determines the T300′ according to the individual services.

The second method for determining the T300′ is determine the T300′ according to the individual cells.

The #_UE_RNC, #_UE_NB, and #_UE_cell described in the aforementioned first method are indicative of continuously-changed parameters, such that the RNC cannot correctly recognize the parameters.

A correct value T300′ cannot be calculated using Equation 1, but only its approximate value can be calculated. Therefore, a method for calculating the value of T300′ for each cell on the assumption that the number of UEs is fixed to a predetermined number in association with all of the services may be simpler and more effective than the other method for calculating the value of T300′ for each service and continuously updating the value of the T300′ according to the changed number of UEs.

The case of determining the conventional value of T300 may be considered to be a subset used for the other case in which the T300′ is determined according to the individual services. In more detail, #_UE_RNC, #_UE_NB, and #_UE_cell values are each fixed to a predetermined value, T_processing_RNC, T_Iub_{—}1, T_Iub_{—}2, and T_air_{—}2 are calculated such that the value of T300′ for each cell is determined. In other words, the T_processing_RNC is associated with not only the #_UE_RNC, but also the processing capability of the RNC. The T_air_{—}2 is associated with not only the #_UE_cell, but also a quantity of FACH resources of the cell. In brief, the higher the processing capability of the RNC, the lower the T_processing_RNC. The higher the quantity of the FACH resources of the cell, the lower the T_air_{—}2. Therefore, the value of T300′ is determined according to the quantity of the FACH resources for each cell.

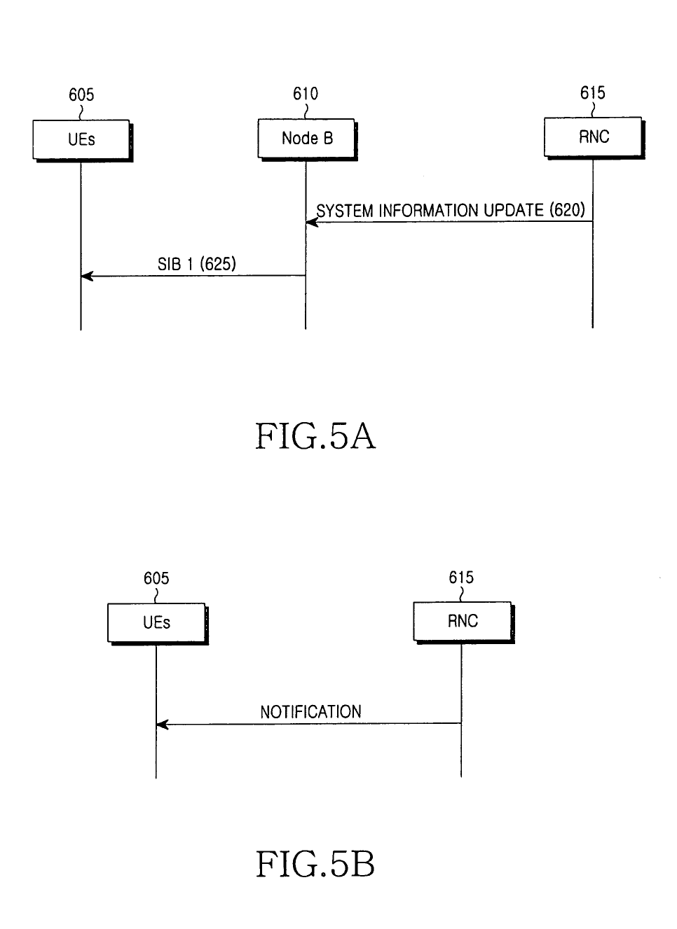

FIGS. 5A and 5B are flow charts illustrating the processes for transmitting the determined T300′ to the UE in accordance with the present invention. In more detail, the RNC transmits the determined T300′ to the UE using system information, or transmits it over a notification message.

FIG. 5A is a flow chart illustrating a procedure for transmitting the determined time information using the MBMS system information in accordance with a preferred embodiment of the present invention.

The system information is an announcement of information sent to all of the UEs contained in a specific cell over a common channel referred to as a P-CCPCH (Primary—Common Control Physical Channel). The system information is configured in the form of an SIB (System Information Block), and is then transmitted to the UEs. The SIB is assigned an ID number according to the categories of the information, including the SIB. For example, the timer values commonly used in a specific cell are transmitted over an SIB 1, and the common channel information contained in the cell is transmitted over an SIB 5. The conventional value of T300 for each cell is well known using the SIB 1, such that the other value of T300′ may also be transmitted using the SIB 1. The following description will be disclosed on the assumption that the value of T300′ is well known using the SIB 1.

The RNC 615 determines the value of T300′ for each cell, and transmits the system information update message including the SIB 1 having the determined T300′ to the Node B 610 controlling the cell. The SIB1 and its scheduling information are contained in the system information update message, and the Node B 610 periodically transmits the SIB1 625 to a corresponding cell according to the scheduling information. Therefore, a plurality of UEs 605 who wish to receive a predetermined MBMS receive the SIB1. The UEs 605 confirm the value of T300′ using the SIB1, and store the confirmed value.

The UEs 605 retransmit the RRC connection request message according to the value of T300′.

FIG. 5B is a flow chart illustrating a procedure for transmitting the T300′ using the notification message in accordance with another preferred embodiment of the present invention. The notification message is a message indicating that a specific MBMS start time draws near, and includes the following information, i.e. a message type, an MBMS ID, and RRC connection required information.

The message type is equal to the information for indicating the notification.

The MBMS ID is equal to ID information of an MBMS acting as a notification target.

The RRC connection required information is indicating if the UEs receiving the notification message need to establish the RRC connection.

The RNC 615 inserts the aforementioned information and the determined T300′ in the notification message, and transmits the resultant information.

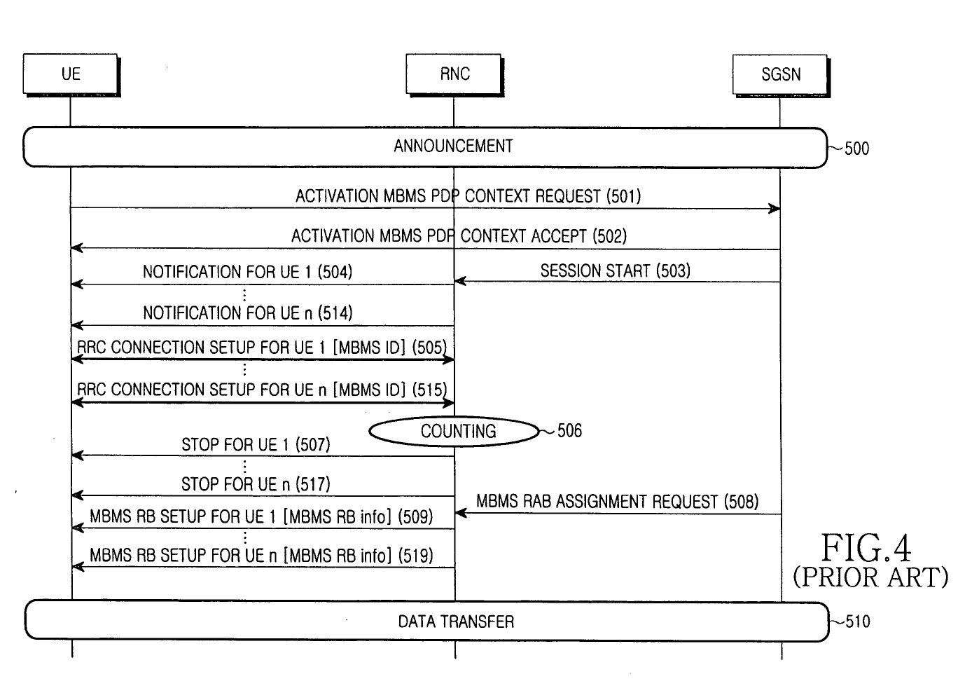

Upon receiving a session start message (see step 503 of FIG. 4) indicating the impending start of a specific MBMS from the SGSN, the RNC transmits the Notification-N message to the cells serving as session start targets. In this case, it is expected that each cell includes UEs having requested the MBMS. The UEs 605 having received the notification message store the value of T300′.

Therefore, the UEs 605 retransmits the RRC connection request message according to the value of T300′.

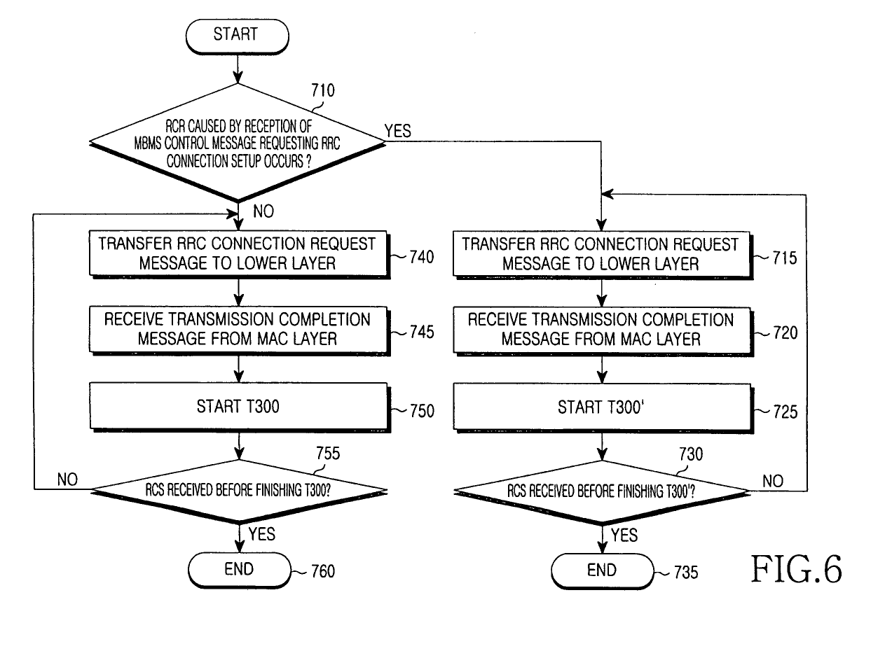

FIG. 6 is a flow chart illustrating a procedure for re-transmitting the RRC connection setup message in accordance with the present invention.

Referring to FIG. 6, the RRC layer of the UE determines if the occurrence of the RRC connection request message is due to the reception of the MBMS control message requesting the RRC connection setup. Upon receipt of the MBMS control message, step 715 is performed. Otherwise, if it is determined that the RRC connection request message has occurred due to other causes, step 740 is performed. Some examples of the other causes are equal to predetermined connection setup cause values such as an incoming or outgoing signal generation.

In this case, an example of the MBMS control message requesting the RRC connection setup may be the notification message. Typically, the notification message requests the RRC connection setup by performing a counting function. However, if needed, the notification message may not request the RRC connection setup in association with a cell, which does not perform the counting function. Therefore, the notification message includes the RRC connection required information for commanding the RRC connection setup attempts of the UEs.

If the RRC connection required information exists in the received MBMS control message, the RRC layer of the UE determines that the MBMS control message requesting the RRC connection setup has been received.

The RRC layer of the UE transmits the RRC connection request message to a lower layer at step 715. The RRC connection request message is transmitted to the RNC over an uplink common channel such as an RACH (Random Access Channel). The physical layer informs the L2/MAC layer of the success or the failure of the RACH transmission. The information of the success or failure of RACH transmission means that data to be transmitted has been transmitted over a radio channel, and has no relation with the fact that data has been received or not.

Upon receiving the information indicative of the success or failure of RACH transmission from the physical layer, the UE's L2/MAC layer transmits a transmission completion message of the RRC connection request message to the UE's RRC layer at step 720.

The UE's RRC layer simultaneously begins operations of the T300′ timer with the receipt of the transmission completion message of the RRC connection request message at step 725.

The UE's RRC layer determines if the RRC connection setup message is received from the RNC before the T300′ timer expires at step 730. The UE's RRC layer receives the RRC connection setup message from the RNC, in such a way that it recognizes that there is no need to retransmit the RRC connection request message. Therefore, if the T300′ timer has expired before the RRC connection setup message is received from the RNC, the UE's RRC layer goes to step 715 to retransmit the RRC connection request message. The UE's RRC layer transmits the RRC connection request message to the lower layer at step 715, and performs a retransmission process of the RRC connection request message.

Otherwise, if the UE's RRC layer receives the RRC connection setup message before the T300′ timer expires, i.e. if the RRC connection request message is successfully transmitted to the RNC, the transmission and retransmission operations of the RRC connection request message are terminated at step 735.

Steps 740˜760 are the transmission and retransmission operations of the conventional RRC connection request message. Particularly, the T300, instead of the T300′, is used for the conventional retransmission operation of the RRC connection request message.

As apparent from the above description, the present invention uses different timers in a normal state and an MBMS provision state when the UE retransmits the RRC connection request message, and performs message retransmission, resulting in a minimal number of retransmissions of unnecessary RRC connection request messages. The RNC can improve a processing speed when performing the RRC connection setup needed for the support of MBMS.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for controlling a UE (User Equipment) to perform an RRC (Radio Resource Control) connection in a mobile communication system capable of supporting an MBMS (Multimedia Broadcast/Multicast Service), comprising the steps of:
a) determining, by a RNC (Radio Access Controller), a timer value corresponding to the MBMS;
b) inserting the determined timer value in a message indicating a start of the MBMS, and transmitting the message including the timer value to the UE; and
c) transmitting, by the UE, an RRC connection request message to the RNC during a time period equal to the determined timer value.

2. The method according to claim 1, wherein the timer value indicates information that varies with the number of UEs requesting the MBMS.

3. The method according to claim 1, wherein the timer value indicates information that varies with the number of UEs contained in the RNC.

4. A method for controlling a UE (User Equipment) to perform an RRC (Radio Resource Control) connection in a mobile communication system capable of supporting an MBMS (Multimedia Broadcast/Multicast Service), comprising the steps of:
a) determining, by a RNC (Radio Access Controller), a timer value corresponding to the MBMS;
b) inserting the timer value in a system information corresponding to the MBMS, and transmitting the system information including the timer value to the UE; and
c) transmitting, by the UE, an RRC connection request message to the RNC during a time period equal to the determined timer value.

5. The method according to claim 4, wherein the timer value indicates information that varies with the number of UEs requesting the MBMS.

6. The method according to claim 4, wherein the timer value indicates information that varies with the number of UEs contained in the RNC.

7. The method according to claim 4, wherein the timer value indicates information, which is contained in the system information and is transmitted to a plurality of Ues, contained in a cell over a common channel.

8. The method according to claim 4, wherein the timer value indicates information, which is periodically transmitted to a plurality Ues, contained in a cell according to scheduling information of the system information.

9. A method for controlling a UE (User Equipment) to perform an RRC (Radio Resource Control) connection in a mobile communication system capable of supporting an MBMS (Multimedia Broadcast/Multicast Service), comprising the steps of:
a) determining, by a RNC (Radio Access Controller), a timer value corresponding to a cell including a UE requesting an MBMS;
b) inserting the timer value in a notification message indicating a start of the MBMS, and transmitting the notification message including the timer value to the UE; and
c) transmitting, by the UE, an RRC connection request message to the RNC during a time period equal to the determined timer value.

10. The method according to claim 9, wherein the timer value indicates information that varies with a processing speed of the RNC and a quantity of uplink radio resources.

11. A method for controlling a UE (User Equipment) to perform an RRC (Radio Resource Control) connection in a mobile communication system capable of supporting an MBMS (Multimedia Broadcast/Multicast Service), comprising the steps of:
a) determining, by a RNC (Radio Access Controller), a timer value corresponding to a cell including a UE requesting an MBMS;
b) inserting the timer value in a system information corresponding to the MBMS, and transmitting the system information including the timer value to the UE; and
c) transmitting, by the UE, an RRC connection request message to the RNC during a time period equal to the determined timer value.

12. A method for controlling a UE (User Equipment) to transmit an RRC (Radio Resource Control) connection request message in a mobile communication system capable of supporting an MBMS (Multimedia Broadcast/Multicast Service), comprising the steps of:
a) determining, by an RRC layer of a UE, if a control message including a timer value corresponding to a cell having the UE is received from a RNC (Radio Access Controller);
b) transmitting the RRC connection request message to the RNC over an uplink common channel when the control message is equal to an MBMS control message; and
c) repeatedly transmitting the RRC connection request message in response to the timer value until receiving a response message from the RNC.

13. A method for controlling a UE (User Equipment) to transmit an RRC (Radio Resource Control) connection request message in a mobile communication system capable of supporting an MBMS (Multimedia Broadcast/Multicast Service), comprising the steps of:
a) determining, by an RRC layer of a UE, if a control message including a timer value corresponding to an MBMS requested by the UE is received from a RNC (Radio Access Controller);
b) transmitting the RRC connection request message to the RNC over an uplink common channel when the control message is equal to an MBMS control message; and
c) repeatedly transmitting the RRC connection request message in response to the timer value until receiving a response message from the RNC.

14. The method according to claim 13, wherein the timer value is determined by
T300′=T_air_{—}1+T_Iub_{—}1+T_processing_{—}RNC+T_Iub_{—}2+T_air_{—}2+MARGIN
where T_air_{—}1 is a radio channel transmission expectation time of the RRC connection request message, T_Iub_{—}1 is a transmission expectation time of an Iub interface for the RRC connection request message, T_processing_RNC is an RRC connection request message processing expectation time of an RNC (Radio Network Controller), T_Iub_{—}2 is an Iub interface transmission expectation time of an RRC connection setup message, T_air_{—}2 is a radio channel transmission expectation time of the RRC connection setup message, and MARGIN is the sum of offset information of the above parameters.
